(19) United States
(12) Patent Application Publication
(10) Pub. No.: US 2011/0017320 A1
(43) Pub. Date: Jan. 27, 2011

(54) Fuel Cutoff valve

(75) Inventors: Hiroaki Kito, Aichi-ken (JP); Hiroshi Nishi, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Kiyosu-shi (JP)

(21) Appl. No.: 12/805,152

(22) Filed: Jul. 15, 2010

(30) Foreign Application Priority Data
Jul. 27, 2009 (JP) 2009-174250
Nov. 26, 2009 (JP) 2009-268416

(51) Int. Cl. F16K 31/18; B65D 90/22

(52) U.S. Cl. 137/423; 220/745

(57) ABSTRACT

A fuel cutoff valve includes a first float mechanism housed in a first valve chamber of a casing, and a second float mechanism housed in a second valve chamber. During fueling operations, when an intake opening becomes blocked by fuel, the second float mechanism closes second vent holes, and the first float mechanism closes a connecting passage. At times other than fueling operations, when the intake opening becomes blocked by fuel, because the fuel tank interior and the first and second valve chambers, communicate through the second vent holes in addition to the first vent holes, differential pressure between tank internal pressure and pressure of the valve chambers does not rise to the point of actuating the closing operation of the first float mechanism, and the fuel tank FT does not become sealed.

This application claims the benefit of and priority from Japanese Applications No. 2009-174250 filed Jul. 27, 2009 and No. 2009-268416 filed Nov. 26, 2009, the contents of which are incorporated herein by reference.

### BACKGROUND OF THE INVENTION

1. Field of the Invention

The present invention relates to a fuel cutoff valve mounted on an upper portion of a vehicle fuel tank, and adapted to allow fuel vapors inside the fuel tank to escape during fueling, while restricting outflow of fuel once the fuel reaches a certain level.

2. Description of the Related Art

In a conventional fuel tank, a fuel cutoff valve having a passage for vaporized fuel gases to escape to the canister is installed in the upper part of the tank. In a typical design, the fuel cutoff valve houses a float that rises and falls with increasing or decreasing buoyancy depending on the fuel level inside the valve chamber, and a valve body that opens and closes the passage is provided in the upper part of the float. When the fuel level in the fuel tank rises, the buoyancy of the float increases, causing the valve body to rise in unison with the float and close the passage so as to prevent fuel from spilling to the outside.

The fuel cutoff valve disclosed as one such design in JP-A 2008-2383 functions as a full tank sensing unit adapted to sense when the tank is full during fueling. Specifically, the full tank sensing unit includes a float, and a casing that defines a valve chamber, and is designed so that when an intake opening in the bottom face of the casing becomes blocked, the internal pressure of the fuel tank rises, whereupon fuel is drawn into the valve chamber due to the differential between tank internal pressure and the valve chamber, thereby causing the float to rise and close off the passage. This brings about a further rise in tank internal pressure which causes the fuel to fill an inlet pipe, whereupon the fuel is sensed by the sensor of the fuel gun to actuate the auto-stop feature. Because a vent hole is provided in the upper part of the casing for maintaining ventilation of the fuel tank interior with the outside even if the fuel tank should tilt due to pitching of the vehicle, the full tank sensing unit also functions as a rollover valve.

With this conventional fuel cutoff valve, when the tank is either full or close to full, if the intake opening becomes blocked by excessive fuel vapors resulting from a rise in fuel temperature during driving for example, the differential pressure between tank internal pressure and valve chamber pressure rises, causing fuel to flow into the valve chamber and actuate the closing operation of the float, so that adequate venting to the outside may not be assured in some instances. To address such situations, it is contemplated to devise means for enlarging the passage area of the vent hole so as to avoid such high differential pressure and thereby prevent actuation of the closing operation of the float. Increasing the passage area of the vent hole means that the differential pressure cannot rise quickly during fueling, resulting in a tendency to overfill. Thus, a resultant problem is that it is difficult, through adjustments of the vent hole passage area alone, to fulfill the requirements of both preventing closing operation of the float in association with excessive fuel vapors, and preventing overfilling.

### SUMMARY

An advantage of some aspects of the invention is to provide a fuel cutoff valve able to fulfill the requirements of both preventing closing operation of the float as the result of a rise in tank internal pressure of the fuel tank, and preventing overfilling.

According to a first aspect of the invention, there is provided fuel cutoff valve that is to be mounted on an upper portion of a fuel tank, for opening and closing a connecting passage that connects between an inside of the fuel tank and outside. The fuel cut off valve comprises: a casing having a first valve chamber that connects the fuel tank interior with the connecting passage, a second valve chamber that connects to the first valve chamber, a first vent hole situated in an upper part of the first valve chamber and connecting the first valve chamber with the fuel tank interior, a second vent hole situated in an upper part of the second valve chamber and connecting the second valve chamber with the fuel tank interior, and an intake opening situated below the second valve chamber and adapted to be blocked off at a preset fuel level, a first float mechanism housed within the first valve chamber and adapted to open and close the connecting passage according to a fuel level in the first valve chamber, and a second float mechanism housed within the second valve chamber and adapted to open and close the second vent hole according to the fuel level in the second valve chamber (31S). The first vent holes and the second vent holes are constituted such that differential pressure arising between tank internal pressure and pressure of the first valve chamber reaches a first differential pressure during fueling operations, and the differential pressure reaches a second differential pressure lower than the first differential pressure at times other than fueling operations, when the fuel level reaches the preset fuel level and the intake opening is blocked off by fuel. The first differential pressure is a value such that fuel is drawn into the first and second valve chamber, and the second float mechanism ascends and closes off the second vent holes and the first float mechanism ascends and closes off the connecting passage, and the second differential pressure is a value such that fuel is drawn in at a level below that at which the second float mechanism closes off the second vent holes.

In a fuel tank incorporating the fuel cutoff valve according to a first aspect, during fueling, as the fuel level rises and fuel blocks the intake opening, a first differential pressure arises between tank internal pressure and the valve chamber, whereupon fuel flows into a second flow chamber and a second float mechanism closes off a second vent hole, and as fuel rapidly enters a first valve chamber, a first float mechanism ascends to the ascended position at which an upper valve body closes off the connecting passage, thereby preventing spillage of fuel from the fuel tank to the outside. In this valve closing operation that takes place during fueling, because the second float mechanism closes off a second vent hole, the only passage connecting the fuel tank interior with the outside is the first vent hole, which has relatively small passage area. A large drop in tank internal pressure can thus be avoided so as to prevent overfilling.

Further, with the tank close to full at times other than fueling up, if fuel blocks the intake opening as the result of a rise in tank internal pressure caused by driving or by elevated temperature of the fuel tank, the differential pressure arising at this point in time is a second differential pressure smaller than the first differential pressure that arises during fueling, moreover at this point, the second vent holes supplement the first vent holes as passages connecting the fuel tank interior, the first valve chamber, and the second valve chamber, so the differential pressure is rapidly dispelled. That is, the differential pressure is not sufficiently great that fuel enters the first valve chamber to the point of lifting the first float mechanism. Thus, the first float mechanism does not actuate the valve closing operation, and venting through the first vent holes is maintained so that the fuel tank does not become sealed.

A second aspect features positioning the second float mechanism below the first float mechanism. According to this feature, fuel inside the fuel tank is less likely to enter the valve chamber owing to the greater height inside the intake passage, so the float mechanism is not lifted inadvertently.

A third aspect features a casing that includes a first valve chamber-defining member having a cylindrical side wall partially defining the first valve chamber, and a second valve chamber-defining member partially defining the second valve chamber, the second valve chamber-defining member includes upper walls of larger diameter in the horizontal direction starting at the lower end of the first valve chamber-defining member, and a cylindrical wall that projects downward from the outside perimeter of the upper walls, and second vent holes are formed in the upper wall. According to this feature, because the upper walls formed in the second valve chamber-defining member are continuous with vertical walls, the outside diameter of the second valve chamber-defining member can be smaller by the equivalent of the diametrical distance between the vertical walls, making the fuel cutoff valve more compact.

A fourth aspect features positioning the second float mechanism to a horizontal side of the first float mechanism. According to this feature, because the fuel cutoff valve is not excessively tall, the full tank level can be established above it, thereby minimizing dead space. The feature is also adaptable to a flat fuel tank.

A fifth aspect features an upper wall having at the rim of the second vent hole thereof a passage-defining projection that projects towards the second valve chamber side and seats against a seal face at the top face of the second float mechanism. The passage-defining projection provides enhanced sealing through linear contact against the second float mechanism.

A sixth aspect features the aforementioned upper wall wherein the second vent holes and the passage-defining projections are positioned in the outside peripheral part of the second valve chamber-defining member on a first diagonal axis passing through the center thereof, stoppers are positioned in the outside peripheral part on a second diagonal axis orthogonal to the first diagonal axis, and the stoppers have height such that seating thereof against the seal face takes place substantially at the same time as the passage-defining projections. According to this feature, contact of the stoppers takes place substantially simultaneously with the second float mechanism seated against the passage-defining projections of the second vent holes, thereby preventing the second float mechanism from tilting, and enhancing sealing.

A seventh aspect features a first valve chamber-defining member provided with vertical walls defined by vertically deformed portions at either side of a cylinder, the second valve chamber-defining member includes upper walls connected to the vertical walls and arranged on the horizontal, and the second vent holes are formed in the upper walls. Because the upper walls formed in the second valve chamber-defining member are continuous with vertical walls, the outside diameter of the second valve chamber-defining member can be smaller by the equivalent of the diametrical distance between the vertical walls, making the fuel cutoff valve more compact.

An eighth aspect features the aforementioned upper walls wherein the second vent holes and the passage-defining projections are situated in the outside peripheral part of the upper walls on a first diagonal axis passing through the center of the second valve chamber-defining member, and stoppers are situated on a second diagonal axis orthogonal to the first diagonal axis. A ninth aspect features the aforementioned first valve chamber-defining member having arcuate walls that connect the vertical walls in the circumferential direction, the second valve chamber-defining member includes sloping walls connecting the lower part of the arcuate walls with the upper part of a cylindrical wall, and the stoppers are formed to the inward side from the sloping walls. According to a tenth aspect, the first valve chamber-defining member and the second valve chamber-defining member are formed by cylinders of equal diameter, thereby affording a more compact fuel cutoff valve.

These and other objects, features, aspects, and advantages of the present invention will become more apparent from the following detailed description of the preferred embodiments with the accompanying drawings.

### BRIEF DESCRIPTION OF THE DRAWINGS

FIG. 1 is a sectional view depicting a fuel cutoff valve installed in the upper part of a fuel tank of an automobile according to a first embodiment of the invention;

FIG. 2 is an exploded sectional view of the fuel cutoff valve;

FIG. 3 is an exploded perspective, partially fragmentary view of the bottom part of the fuel cutoff valve;

FIG. 4 is a sectional view depicting the vicinity of an upper valve body;

FIG. 5 is an exploded perspective view of the upper valve body;

FIG. 6 shows the operation of the fuel cutoff valve;

FIG. 7 shows another operation of the fuel cutoff valve;

FIG. 8 is a sectional view depicting a fuel cutoff valve according to a second embodiment;

FIG. 9 is a sectional view depicting a horizontal section taken above a second valve chamber-defining member of a fuel cutoff valve according to a third embodiment;

FIG. 10 is a perspective, partially fragmentary view of the lower part of a casing body and a second float mechanism;

FIG. 11 is a sectional view taken along line 11-11 in FIG. 9;

FIG. 12 is a sectional view taken along line 12-12 in FIG. 9; and

FIG. 13 is a sectional view depicting a casing body in a fourth embodiment.

### DESCRIPTION OF THE PREFERRED EMBODIMENTS

### (1) General Features of Fuel Cutoff Valve 10

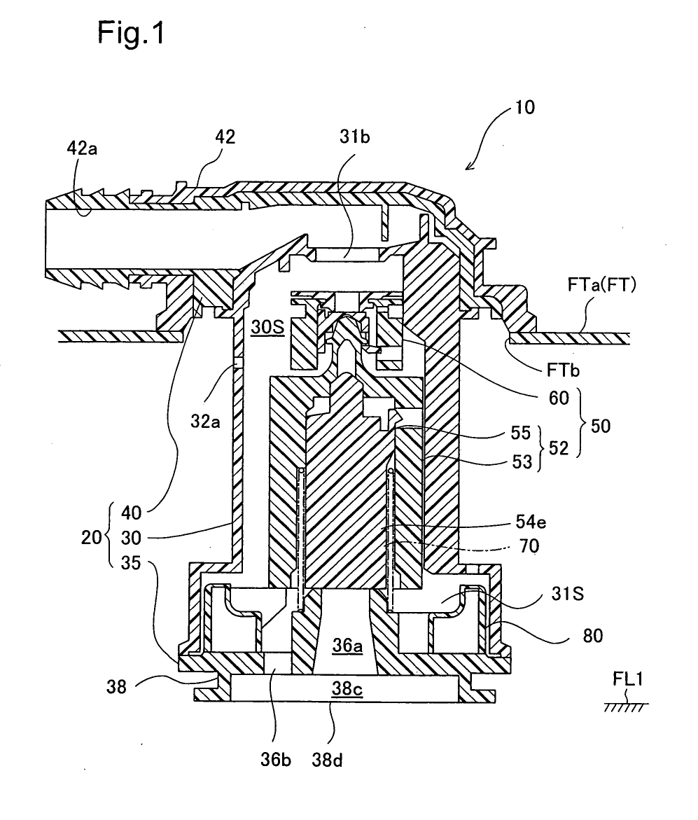

FIG. 1 is a sectional view depicting a fuel cutoff valve 10 installed in the upper part of a fuel tank FT of an automobile according to a first embodiment of the invention. The fuel tank FT in FIG. 1 is formed of composite resin material that includes a surface of polyethylene. A mounting hole FTb is formed in the tank upper wall FTa. The fuel cutoff valve 10 is attached to the tank upper wall FTa with the lower part thereof protruding into the mounting hole FTb. The fuel cutoff valve 10 restricts outflow to the canister when the fuel level in the fuel tank rises to a preset level during fueling; actuates an auto-stop function to prevent overfilling; and also functions as a rollover valve to prevent fuel from spilling out if the vehicle pitches. The fuel cutoff valve 10 comprises primarily of a casing 20, a first float mechanism 50, a spring 70, and a second float mechanism 80. The casing 20 includes a casing body 30, a base member 35, and a cover 40; the space bounded by the casing body 30 and the base member 35 constitutes a first valve chamber 30S and a second valve chamber 31S. The first float mechanism 50, supported by the spring 70, is housed in the first valve chamber 30S, while the second float mechanism 80 is housed in the second valve chamber 31S, respectively.

### (2) Features of Individual Parts of Fuel Cutoff Valve 10

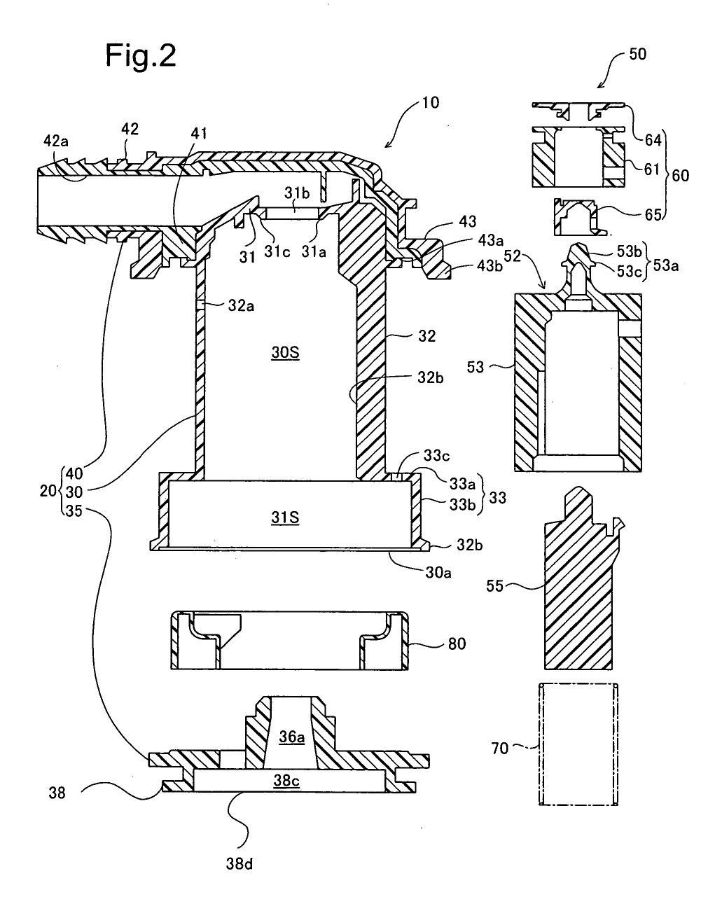

FIG. 2 is an exploded sectional view of the fuel cutoff valve 10. The casing body 30 is cup shaped bounded by a ceiling wall portion 31, a first valve chamber-defining member 32, and a second valve chamber-defining member 33 enlarged in diameter beyond the lower part of the first valve chamber-defining member 32; and has an opening 30a at the bottom. The first valve chamber 30S is bounded by the first valve chamber-defining member 32 and houses the first float mechanism 50, while the second valve chamber 31S is bounded by the second valve chamber-defining member 33 and houses the second float mechanism 80. That is, the second valve chamber-defining member 33 defines the second valve chamber 31S by virtue of including an upper wall 33a enlarged in diameter beyond the first valve chamber-defining member 32, and a cylindrical wall 33b of cylindrical contours projecting from the outside perimeter of the upper wall 33a. In the center part of the ceiling wall portion 31 there a formed a passage-defining projection 31a that projects downward; a connecting passage 31b that connects with the first valve chamber 30S passes through this passage-defining projection 31a. The first valve chamber 30S side of the connecting passage 31b constitutes a first seal portion 31c. First vent holes 32a for connecting the first valve chamber 30S to the fuel tank FT interior are formed in the first valve chamber-defining member 32. The first vent holes 32a are passage holes positioned above a first fluid level FL1 (FIG. 1) arranged at two locations spaced 180° apart in the circumferential direction, and 1.5 mm in diameter. Second vent holes 33c 2.0 mm in diameter for connecting the second valve chamber 31S to the fuel tank FT are formed in the upper wall 33a of the second valve chamber-defining member 33. The second vent holes 33c are passage holes positioned above the first fluid level FL1 (FIG. 1) and below the first vent holes 32a, and arranged at two locations spaced 180° apart in the circumferential direction. Case-mounted guide portions 32b of rib shape for guiding the float mechanism 50 are disposed at eight locations along the circumferential direction of the inside wall of the first valve chamber-defining member 32.

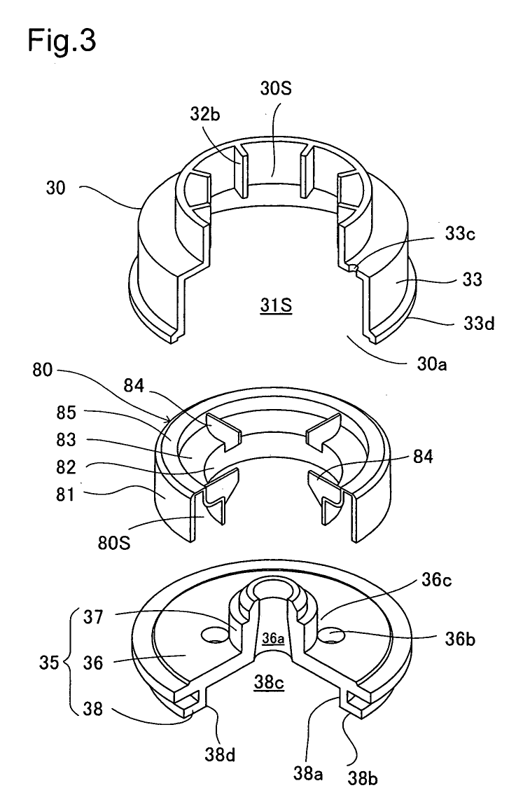

FIG. 3 is an exploded perspective, partially fragmentary view of the bottom part of the fuel cutoff valve 10. In FIG. 3, the base member 35 is a member that provides partial closure to the opening 30a of the casing body 30, and is adapted to intake liquid fuel and fuel vapors inside the first valve chamber-defining member 30S. The base member 35 includes a base plate 36 welded to a flange 33d at the bottom end of the casing body 30; a center projection 37 that projects out from the center part of the base plate 36; and an intake passage-defining member 38 formed extending downward from the outside peripheral part of the base plate 36. A flow passage hole 36a passes through the center projection 37, and additional flow passage holes 36b pass through at four locations encircling the flow passage hole 36a. A spring support portion 36c adapted to support the lower end of the spring 70 is formed on the upper face of the base plate 36. The intake passage-defining member 38 includes a cylindrical part 38a, and a disk part 38b enlarged in diameter beyond the lower end of the cylindrical part 38a; the inside thereof constitutes an intake passage 38c and connects with the flow passage holes 36a, 36b from an intake opening 38d in the lower part.

In FIG. 2, the cover 40 is an integrally formed component incorporating a cover body 41, a pipe part 42 that projects out to the side from the center of the cover body 41, and a flange 43 formed at the outside perimeter of the cover body 41. A pipe passage 42a is formed in the pipe part 42; this pipe passage 42a connects at one end to the first valve chamber 30S of the casing body 30 through the connecting passage 31b, and connects at the other end to the canister (not shown) end. An inner welding portion 43a for welding to the upper end of the casing body 30 is formed in the lower part of the cover body 41, and an outer welding portion 43b for welding to the tank upper wall FTa of the fuel tank FT is formed on the lower edge of the flange 43.

The first float mechanism 50 includes a float 52 and an upper valve body 60 disposed in the upper part of the float 52. The float 52 includes a first float portion 53 and a second float portion 55 unified into an integral assembly through interlocking claws for example. The spring 70 is interposed in the gap between the first float portion 53 and the second float portion 55, thereby urging the first float mechanism 50 upward. A valve support portion 53a is formed in the upper part of the first float portion 53.

The valve support portion 53a is a component adapted to support the upper valve body 60 in bobbing fashion, and is provided with a support portion 53b composed of a substantially conical shaped projection (convex shape). An annular projecting portion 53c is formed around the outside peripheral part of the valve support portion 53a to prevent the upper valve body 60 from becoming dislodged.

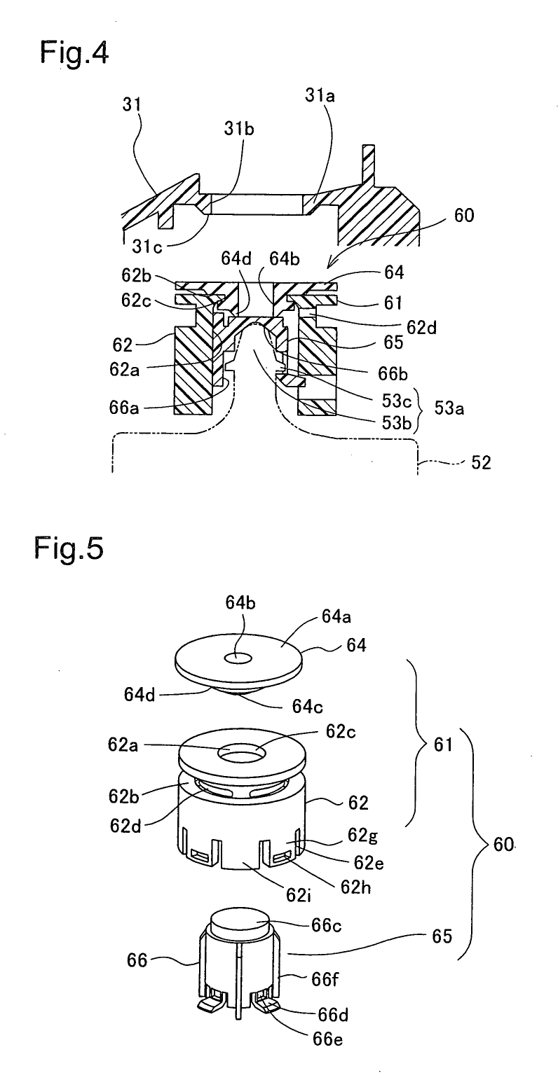

FIG. 4 is a sectional view of the proximity of the upper valve body 60, and FIG. 5 is an exploded perspective view of the upper valve body 60. The upper valve body 60 is a valve affording improved valve reopening characteristics; the valve is supported in ascending/descending and bobbing fashion by the valve support portion 53b of the float 52, and includes a first valve portion 61, a seat member 64 installed in the first valve portion 61, and a second valve portion 65. The first valve portion 61 has a substantially cylindrical first valve body 62, and a support hole 62a extends in the axial direction inside the first valve body 62. A mounting portion 62b adapted for mounting the seat member 64 is formed in the upper part of the first valve body 62. An annular recess 62c is formed in the outside peripheral part of the first valve body 62, and vent holes 62d for connecting the support hole 62a to the outside are formed at four locations in the annular recess 62c. FIG. 5 is an exploded perspective view of the upper valve body 60. Slits 62e are formed in the lower part of the first valve body 62; elastically deformable locking pieces 62g are formed from fastening pieces 62i by the slits 62e. Locking holes 62h are formed in the locking pieces 62g.

The seat member 64 includes a first seat portion 64a adapted to seat against and release from the first seal portion 31c (FIG. 4); a connecting hole 64b that connects to the support hole 62a; a seal portion 64c formed at the lower end of the connecting hole 64b; and a mounting portion 64d, these components being integrally formed from rubber material. The seat member 64 is installed in the mounting portion 62b of the first valve body 62 by means of the mounting portion 64d; and by virtue of having a gap between the first seat portion 64a and the upper face of the first valve body 62, is capable of elastic deformation when seated against the first seal portion 31c, so as to afford enhanced sealing.

The second valve portion 65 includes a second valve body 66 of cylindrical shape. A bottomed hole 66a (FIG. 4) open at the bottom is formed inside the second valve body 66, and a supported portion 66b of recessed shape is formed at the center of the floor of this bottomed hole 66a. This supported portion 66b rests on the support portion 53b of the float 52 so that the second valve portion 65 is supported in bobbing fashion with the support portion 53b as the fulcrum. A second seat portion 66c is formed on the upper face of the second valve body 66, the second seat portion 66c being formed such that the connecting hole 64b is alternately opened and shut when the first valve portion 61 releases from and seats against the seal portion 64c. Detaining claws 66d are formed at two locations in the lower part of the second valve body 62, and are designed to lock into the locking holes 62h provided in the first valve body 62 so that the first valve portion 61 is supported in ascending/descending fashion with respect to the second valve portion 65. In the upper part of each of the detaining claws 66d there is formed a locking hole 66e designed to mate with the annular projecting portion 53c (FIG. 4) of the float 52, thereby detaining and supporting the second valve portion 65 in ascending/descending fashion with respect to the float 52. Guide ribs 66f for guiding the second valve portion 65 in the vertical direction are formed on the outside peripheral part of the second valve body 66. The guide ribs 66f project out with ribbed contours in the vertical direction at four equidistant locations along the circumference of the side wall of the second valve body 66, and are slidable against the inside wall of the support hole 62a.

In FIG. 3, the second float mechanism 80 is housed within the second valve chamber 31S, and includes a second float body 81 of annular shape that defines a float chamber 80S below. The second float body 81 has a inner space 82 accommodating insertion of the center projection 37 (FIG. 2) of the base member 35, and supports the first float mechanism 50 via pedestals 84 formed at four locations on a shoulder portion 83. The upper face of the second float body 81 constitutes a seal face 85, and is formed so that with the second float mechanism 80 is in the ascended position, the second vent holes 33c are blocked.

### (3) Operation of Fuel Cutoff Valve 10

### (3)-1 Operation During Fueling

As depicted in FIG. 1, when fuel is supplied into the fuel tank FT during a fueling operation, the fuel vapors that accumulate in the upper part of the fuel tank FT interior as the fuel level in the fuel tank FT rises flow from the intake opening 38d of the intake passage-defining member 38, through the intake passage 38c and the flow passage holes 36a, 36b, and into the second valve chamber 31S and the first valve chamber 30S, as well as flowing into the first valve chamber 30S through the first vent holes 32a. Through the connecting passage 31b and the pipe passage 42a, the fuel vapors then escape from the first valve chamber 30S towards the canister.

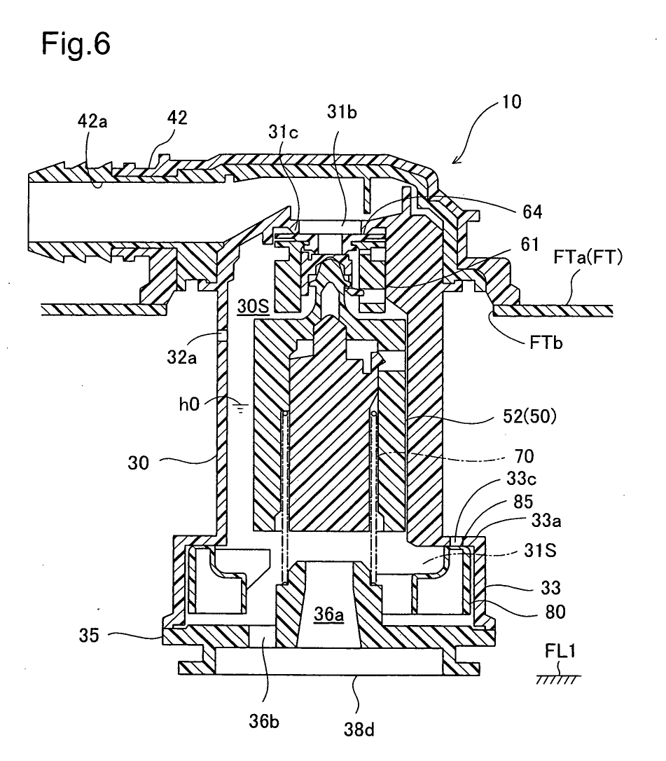

As shown in FIG. 6, when the fuel level inside the fuel tank FT reaches a first fuel level FL1 such that the intake opening 38d is blocked by fuel, venting takes place exclusively through the first vent holes 32a and the second vent holes 33c, which have smaller opening area than the flow passages 36a, 36b, thereby giving rise to differential pressure (first differential pressure) between tank internal pressure and pressure inside the first valve chamber 30S and the second valve chamber 31S, whereupon fuel enters the second valve chamber 31S from the intake opening 38d through the flow passages 36a, 36b, causing the second float mechanism 80 to ascend and the second vent holes 33c to be closed off by the seal face 85; and fuel additionally flows into the first valve chamber 30S, causing the first float mechanism 50 to ascend and the seat member 64 to become seated against the first seal portion 31c, closing off the connecting passage 31b. Because upward movement of the second float mechanism 80 is limited by the upper wall 33a of the second valve chamber-defining member 33, the first float mechanism 50 separates from the second float mechanism 80 as it ascends. In this open valve state, tank internal pressure rises, fuel collects within the inlet pipe, and when the fuel comes into contact with the fueling gun the auto-stop function is actuated. Then, once fueling stops, the fuel inside the first valve chamber 30S is expelled as air enters through the first vent holes 32a, and the first float mechanism 50 descends. However, at this point the second vent holes 33c are still closed off by the second float mechanism 80, and additional fueling would result in the second float mechanism 80 ascending and immediately closing off the second vent holes 33c; thus, additional fueling is prevented.

Meanwhile, as differential pressure between tank internal pressure and pressure in the first valve chamber 30S and the second valve chamber 31S dissipates, and air is drawn into the first valve chamber 30S from inside the fuel tank FT through the first vent holes 32a, the fuel level in the first and second valve chambers 30S, 31S drops, and the first and second float mechanisms 50, 80 descend. Thus, the first float mechanism 50 opens up the connecting passage 31b, and the second float mechanism 80 opens up the second vent holes 33c.

### (3)-2 Operation During Pitching of Vehicle

The fuel cutoff valve 10 in FIG. 1 ensures venting of the fuel tank FT interior to the outside (the canister) through the first vent holes 32a, the second vent holes 33c, the second valve chamber 31S, the first valve chamber 30S, the connecting passage 31b, and the pipe passage 42a. Even if pitching of the vehicle causes the fuel level in the fuel tank FT to reach the first fluid level FL1, the fuel flows gradually into the first valve chamber 30S through the intake passage 38c, the second valve chamber 31S etc., thereby imparting buoyancy which lifts the first float mechanism 50. As the first float mechanism 50 ascends, the upper valve body 60 blocks off the connecting passage 31b, thus preventing fuel from spilling out from the fuel tank FT.

### (3)-3 Operation to Prevent Improper Operation Under Full Tank Conditions

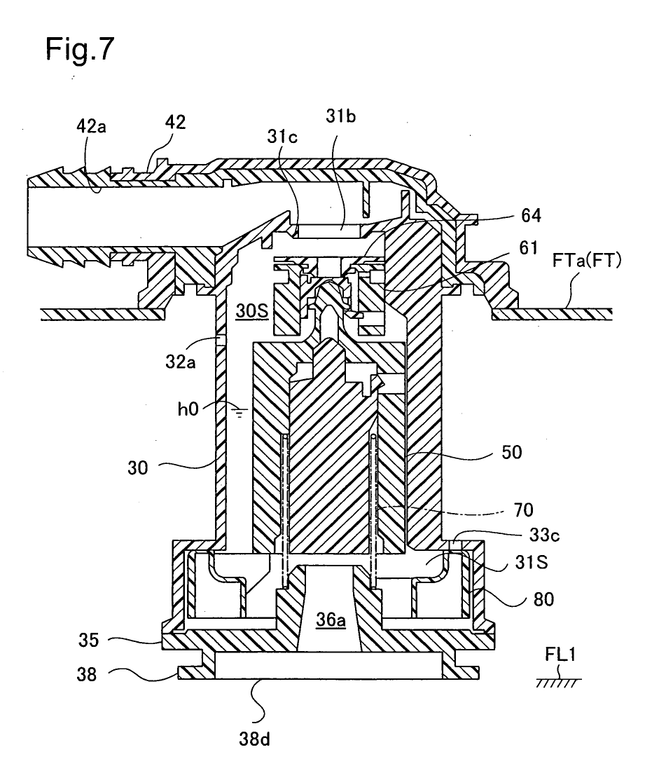

In FIG. 7, the fuel level in the fuel tank FT is close to the first fluid level FL1 (full tank level); and the second float mechanism 80 and the first float mechanism 50 are in the descended position so that the second vent holes 33c and the connecting passage 31b are respectively in the open state. Under these conditions, a rise in tank internal pressure resulting from a rise in temperature inside the fuel tank FT due in turn to a rise in temperature of the air or the vehicle results in the fuel level reaching the lower end of the intake passage-defining member 38 and blocking the intake opening 38d. Differential pressure between tank internal pressure and pressure in the second valve chamber 31S and the first valve chamber 30S results in fuel flowing into the second valve chamber 31S. However, because this differential pressure represents a second differential pressure that is lower than the first differential pressure observed during fueling, the fluid level in the first valve chamber 30S remains low enough that the second float mechanism 80 does not close off the second vent holes 33c, so the first float mechanism 50 does not ascend but rather remains in the descended position. Specifically, because the passage area connecting the fuel tank FT interior and the first valve chamber 30S now includes the second vent holes 33c in addition to the first vent holes 32a, the fuel inflow to the first valve chamber 30S resulting from the second differential pressure does not reach a level sufficient for the second float mechanism 80 to close off the second vent holes 33c, and the closing operation of the first float mechanism 50 is not actuated. Accordingly, venting to the outside is assured via the first vent holes 32a, and the fuel tank FT does not become sealed.

### (4) Effects of the Embodiment

The embodiment described above features the following effects. (4)-1 As depicted in FIG. 6, during fueling, when the fuel level rises to the point that fuel blocks the intake opening 38d, a first differential pressure arises between tank internal pressure and the first and second valve chambers 30S, 31S, whereupon fuel enters the second valve chamber 31S, and the second float mechanism 80 ascends and closes off the second vent holes 33c. Additionally, fuel rapidly enters the first valve chamber 30S, causing the first float mechanism 50 to rise and block off the connecting passage 31b, thereby preventing fuel from spilling out from the fuel tank FT. In this valve closing operation taking place during fueling, because the second vent holes 33c are closed off by the second float mechanism 80, the only passages connecting the fuel tank FT interior to the outside are the first vent holes 32a of relatively small passage area, and thus large drops in tank internal pressure may be avoided so as to prevent overfilling.

(4)-2 As depicted in FIG. 7, with the tank close to full at times other than fueling up, if fuel blocks the intake opening 38d as the result of a rise in tank internal pressure resulting from elevated temperature of the fuel tank, the differential pressure arising at this time represents a second differential pressure lower than the first differential pressure that arises during fueling; and moreover at this point, the second vent holes 33c supplement the first vent holes 32a as passages connecting the fuel tank FT interior with the first and second valve chambers 30S, 31S, so the differential pressure is rapidly dispelled. That is, the differential pressure is not great enough for fuel to enter the first valve chamber 30S to the point of lifting the first float mechanism 50. Thus, the first float mechanism 50 does not actuate the valve closing operation, and venting through the first vent holes 32a is maintained so that the fuel tank does not become sealed.

### (5) Other Embodiments

It is to be understood that there is no intention to limit the invention to the embodiment disclosed herein, and that modifications such as the following are to be included among various possible alternative modes considered to fall within the spirit and scope of the invention.

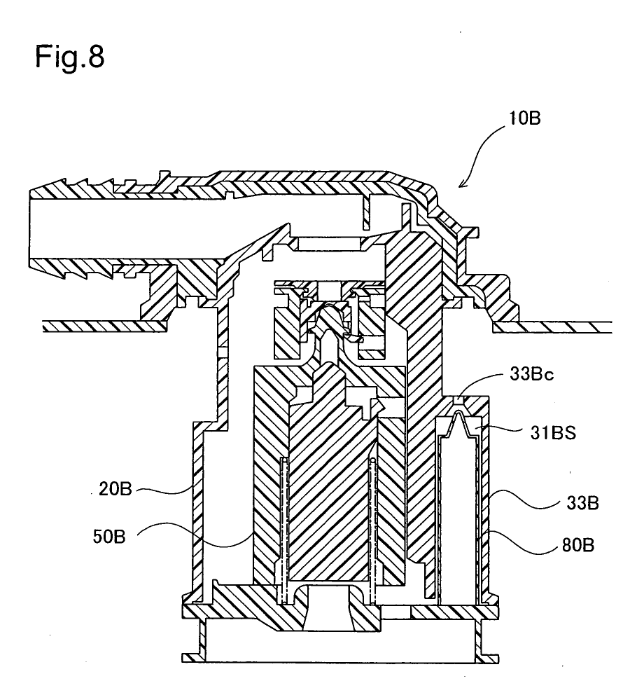

(5)-1 FIG. 8 is a sectional view depicting a fuel cutoff valve 10B according to a second embodiment. A feature of the present embodiment is that the second float mechanism 80B is positioned parallel to the first float mechanism 50B in the horizontal direction. Specifically, the fuel cutoff valve 10B has a second valve chamber-defining member 33B formed jutting out with cylindrical contours from the side of a casing 20B. A second valve chamber 31BS that houses the second float mechanism 80B is formed inside the second valve chamber-defining member 33B. A second vent hole 33Bc 2.8 mm in diameter is formed in the upper wall of the second valve chamber-defining member 33B, and is alternately opened and closed by the second float mechanism 80B. In the present embodiment as well, during fueling, fuel entering the second valve chamber 31BS causes the second float mechanism 80B to ascend and close off the second vent hole 33Bc, thereby preventing overfilling; and due to the large passage area of the second vent hole 33Bc, even if the tank is full and the amount of released fuel vapors is considerable, differential pressure does not rise, and the closing operation of the first float mechanism 50B is not actuated.

Additionally, because the second float mechanism 80B is situated to the side of the first float mechanism 50B, the fuel cutoff valve 10B can be lower in height as compared to Embodiment 1; and by setting the full tank fluid level above it, dead space can be minimized. This design is adaptable to a flat fuel tank.

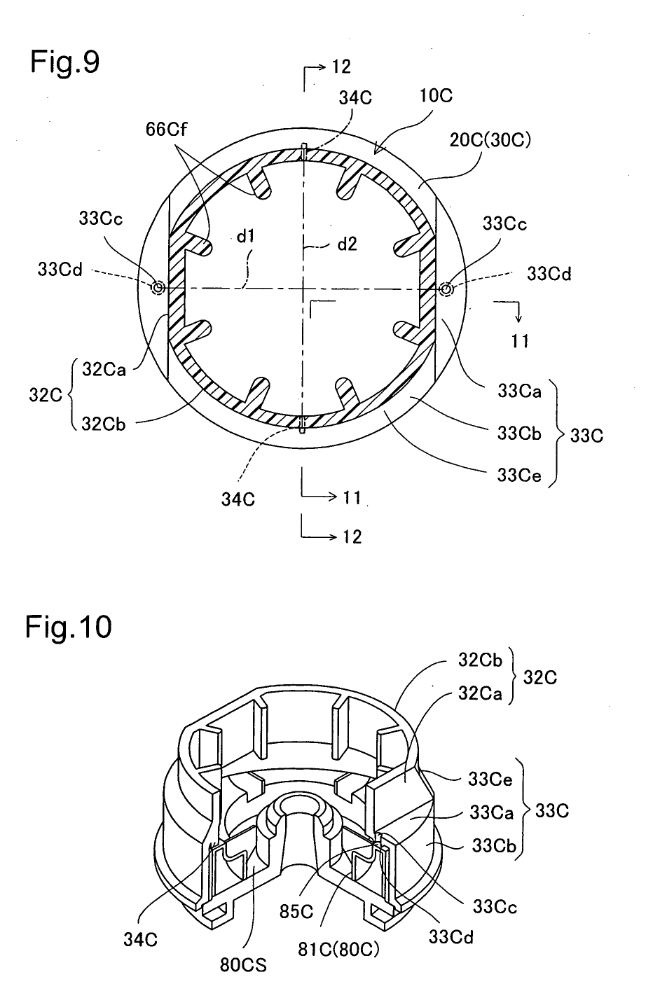

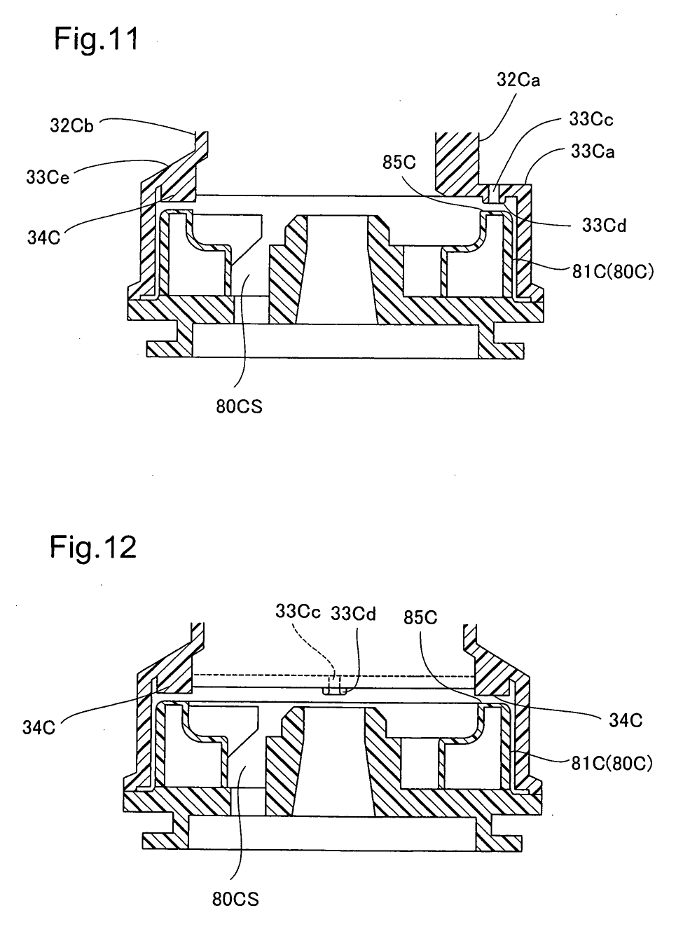

(5)-2 FIG. 9 is a sectional view depicting a horizontal section taken above the second valve chamber-defining member 33C of a fuel cutoff valve 10C according to a third embodiment; FIG. 10 is a perspective, partially fragmentary view of the lower part of a casing body 30C and a second float mechanism 80C; FIG. 11 is a sectional view taken along line 11-11 in FIG. 9; and FIG. 12 is a sectional view taken along line 12-12 in FIG. 9. The present embodiment features an arrangement for the second valve chamber-defining member that houses the second float mechanism, and for the second vent holes. In FIGS. 9 and 10, the casing body 30C includes a first valve chamber-defining member 32C constituting the side walls of a cylinder, and a second valve chamber-defining member 33C enlarged in diameter from the lower part of the first valve chamber-defining member 32C. The first valve chamber-defining member 32C has vertical walls 32Ca constituted by vertically deformed sections at the two sides of the cylinder; in other words, in cross sectional profile taken in the horizontal direction, the vertical walls 32Ca are defined by chord sections, and arcuate walls 32Cb are defined by the remaining arcuate sections. The second valve chamber-defining member 33C includes upper walls 33Ca that extend from the lower edges of the vertical walls 32Ca; sloping walls 33Ce that connect with the arcuate walls; and a cylindrical wall 33Cb that projects downward from the perimeters of the upper walls 33Ca and the sloping walls 33Ce, thereby defining a float chamber 80CS housing the second float mechanism 80C.

Second vent holes 33Cc are respectively formed in the upper walls 33Ca at either side, and are alternately opened and closed by the second float mechanism 80C. In FIG. 9, the two second vent holes 33Cc respectively formed in the upper walls 33Ca are situated at 180° locations across the center of the second valve chamber-defining member 33C, that is, on a diametrical axis (first diametrical axis d1). As shown in FIGS. 9 and 11, a passage-defining projection 33Cd (FIG. 10) is formed along the rim of each of the second vent holes 33Cc, and provides improved sealing through linear contact against the seal face 85C of the second float mechanism 80C. Also, as shown in FIGS. 9 and 12, stoppers 34C that face downward from the second vent holes 33Cc respectively project out from the inner wall of the sloping walls 33Ce. The stoppers 34C are arranged on the perpendicular with respect to the second vent holes 33Cc (second diametrical axis d2), i.e., they are staggered 90° in the circumferential direction from the second vent holes 33Cc. As shown in FIG. 12, the lower ends of the stopper 34C extend down to a horizontal location coequal with the lower ends of the passage-defining projections 33Cd, that is, so as to contact the seal face 85C of the second float body 81 at the same time.

The reason for providing the stoppers 34C is as follows. As mentioned above, a fairly small value is selected for the passage area of the second vent holes 33Cc to ensure that during fueling the fuel entering the valve chambers as the result of differential pressure between the valve chambers and tank internal pressure during fueling gives rise to ascension of the first float mechanism, and to ensure that overfilling does not occur. In order to form second vent holes 33Cc having such small passage area, considerations relating to die molding properties of the resin and axial symmetry make it desirable to form holes about 2 mm in diameter at two locations in the diametrical direction. However, where the second vent holes 33Cc provided at two locations, and moreover the passage-defining projections 33Cd are formed along the rims of the second vent holes 33Cc, with the valves in the closed state, the seal face 85C of the second float body 81C comes into abutment against the passage-defining projections 33Cd exclusively at the two ends of the first diametrical axis d1 so that gaps form to either side of the second diametrical axis d2, resulting in a tendency to tilt and diminished sealing. As depicted in FIG. 12, the stoppers 34C function to eliminate the gaps on the second diametrical axis, specifically, to experience contact at the same time as seating of the seal face 85C against the passage-defining projections 33Cd in order to reduce tilting of the second float body 81C and improve sealing ability.

As shown in FIG. 10, in the present embodiment, the first valve chamber-defining member 32C is partially defined by the vertical walls 32Ca, the upper walls 33Ca are provided as horizontal walls connected to the vertical walls 32Ca, and the second vent holes 33Cc are formed in the horizontal upper walls 33Ca, thereby affording enhanced sealing. The upper walls 33Ca are formed by deforming sections of the cylindrical profile the first valve chamber-defining member 32C to produce the vertical walls 32Ca, thereby avoiding a large outside diameter so as to achieve a compact size. Additionally, because the first valve chamber-defining member 32C is composed of arcuate walls 32Cb at locations apart from the vertical walls 32Ca, the passage through the first valve chamber, i.e. the passage running between the guide ribs 66Cf (FIG. 9) can be larger, and airflow resistance can be reduced.

Because the second vent holes 33Cc are formed in the horizontal upper walls 33Ca at locations devoid of undulation associated with the complex contours of the guide ribs 66Cf, resin injection molding is a simple matter. Additionally, because the stoppers 34C project downward from the inside faces of the sloping walls 33Ce, provided that the direction of mold release is the axial direction, the die can be a simple one, and resin injection molding is a simple matter.

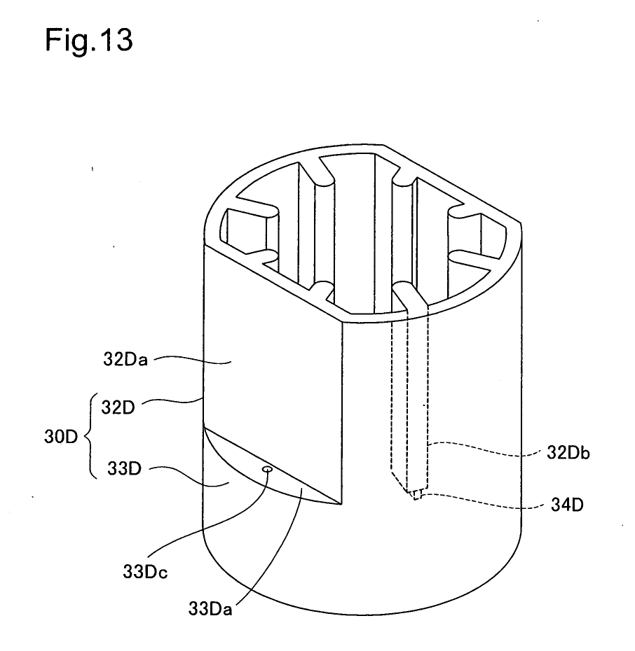

(5)-3 FIG. 13 is a sectional view depicting a casing body in a fourth embodiment. The casing body 30D includes a first valve chamber-defining member 32D and a second valve chamber-defining member 33D formed by cylinders of identical outside diameter; and vertical walls 32Da formed by vertically deformed sections to either side of the cylinder of the first valve chamber-defining member 32D. Upper walls 33Da composed of horizontal walls connect with the vertical walls 32Da. Second vent holes 33Dc are formed in the upper walls 33Da. According to the present embodiment, because the casing body 30D has unchanging outside diameter along its entire length, a more compact size can be achieved. In the present embodiment, stoppers 34D projecting from the lower ends of case guide portions 32Db may be provided by way of a stopper arrangement comparable to that of Embodiment 3.

(5)-4 Generic fuel cutoff valve arrangements may be selected appropriately to be employed as arrangements for the second valve chamber-defining member, the second valve chamber, and the second float mechanism. Examples include means for urging the second float mechanism upward by a spring, or using a material lighter than the specific gravity of the fuel in order to make the second float mechanism easier to float.

(5)-5 Whereas the preceding embodiments described arrangements provided with a single second float mechanism, no limitation is imposed thereby; an arrangement of several mechanisms positioned in the circumferential direction is also possible.

The foregoing detailed description of the invention has been provided for the purpose of explaining the principles of the invention and its practical application, thereby enabling others skilled in the art to understand the invention for various embodiments and with various modifications as are suited to the particular use contemplated. The foregoing detailed description is not intended to be exhaustive or to limit the invention to the precise embodiments disclosed. Modifications and equivalents will be apparent to practitioners skilled in this art and are encompassed within the spirit and scope of the appended claims.

What is claimed is:

1. A fuel cutoff valve that is to be mounted on an upper portion of a fuel tank, for opening and closing a connecting passage that connects between the fuel tank interior and outside, the fuel cut off valve comprising:
a casing having (i) a first valve chamber that connects the fuel tank interior with the connecting passage, (ii) a second valve chamber that connects to the first valve chamber, (iii) a first vent hole situated in an upper part of the first valve chamber and connecting the first valve chamber with the fuel tank interior, (iv) a second vent hole situated in an upper part of the second valve chamber and connecting the second valve chamber with the fuel tank interior, and (v) an intake opening situated below the second valve chamber and adapted to be blocked off at a preset fuel level;
a first float mechanism housed within the first valve chamber and adapted to open and close the connecting passage according to a fuel level in the first valve chamber; and
a second float mechanism housed within the second valve chamber and adapted to open and close the second vent hole according to the fuel level in the second valve chamber,
wherein the first vent hole and the second vent hole are constituted such that differential pressure arising between tank internal pressure and pressure of the first valve chamber reaches a first differential pressure during fueling operations, and the differential pressure reaches a second differential pressure lower than the first differential pressure at times other than fueling operations, when the fuel level reaches the preset fuel level and the intake opening is blocked off by fuel; wherein
the first differential pressure is a value such that fuel is drawn into the first and second valve chambers, and the second float mechanism ascends and closes the second vent hole and the first float mechanism ascends and closes the connecting passage; and
the second differential pressure is a value such that fuel is drawn in at a level below that at which the second float mechanism closes the second vent hole.

2. The fuel cutoff valve in accordance with claim 1 wherein
the second float mechanism is situated below the first float mechanism.

3. The fuel cutoff valve in accordance with claim 2, wherein
the casing includes a first valve chamber-defining member that forms a cylindrical side wall defining part of the first valve chamber, and a second valve chamber-defining member defining part of the second valve chamber; and
the second valve chamber-defining member includes an upper wall of enlarged diameter in the horizontal direction from a lower end of the first valve chamber-defining member, and a cylindrical wall projecting downward from an outside perimeter of the upper wall, the second vent hole being formed in the upper wall.

4. The fuel cutoff valve in accordance with claim 3 wherein
the upper wall has a passage-defining projection that is disposed along a rim of the second vent hole and projects towards the second valve chamber, the passage-defining projection being configured to seat against a seal face on an upper face of the second float mechanism.

5. The fuel cutoff valve in accordance with claim 4, wherein
the second vent hole consists of two though holes that are situated in an outside peripheral portion of the upper wall on a first diametrical axis passing through a center of the second valve chamber-defining member, and
the upper wall includes stoppers that are situated in the outside peripheral portion on a second diametrical axis orthogonal to the first diametrical axis; the stoppers having height such that seating thereof against the seal face takes place at substantially the same time as the passage-defining projections.

6. The fuel cutoff valve in accordance with claim 2, wherein
the first valve chamber-defining member includes vertical walls defined by vertically deformed portions at either side of a cylinder;
the second valve chamber-defining member includes upper walls connected to the vertical walls and arranged on the horizontal; and
the through holes of the second vent hole are formed in the upper walls.

7. The fuel cutoff valve in accordance with claim 6 wherein
the upper wall has a passage-defining projection that is disposed along a rim of the second vent hole and projects towards the second valve chamber, the passage-defining projection being configured to seat against a seal face on an upper face of the second float mechanism.

8. The fuel cutoff valve in accordance with claim 7, wherein
the second vent hole consists of two through holes that are situated in an outside peripheral portion of the upper wall on a first diametrical axis passing through a center of the second valve chamber-defining member, and
the upper wall includes stoppers that are situated in the outside peripheral portion on a second diametrical axis orthogonal to the first diametrical axis; the stoppers having height such that seating thereof against the seal face takes place at substantially the same time as the passage-defining projections.

9. The fuel cutoff valve in accordance with claim 8, wherein
the first valve chamber-defining member has arcuate walls that connect the vertical walls in the circumferential direction;
the second valve chamber-defining member includes sloping walls connecting a lower part of the arcuate walls with an upper part of the cylindrical wall; and
the stoppers are formed to an inward side from the sloping walls.

10. The fuel cutoff valve in accordance with claim 2, wherein
the casing includes a first valve chamber-defining member that forms a cylindrical side wall defining part of the first valve chamber, and a second valve chamber-defining member that forms a cylindrical side wall with identical outside diameter to the first valve chamber-defining member and defining part of the second valve chamber; and
the first valve chamber-defining member includes vertical walls defined by vertically deformed portions at either side of the vertical walls; and
the second valve chamber-defining member includes upper walls connected to the vertical walls and arranged on the horizontal; and having a second vent hole being formed in the upper walls.

11. The fuel cutoff valve in accordance with claim 1 wherein
the second float mechanism is situated to a horizontal side of the first float mechanism.
